(19) United States
(12) Patent Application Publication
(10) Pub. No.: US 2024/0349294 A1
(43) Pub. Date: Oct. 17, 2024

(54) METHOD AND APPARATUS FOR DETECTING PDCCH, METHOD AND APPARATUS FOR TRANSMITTING PDCCH, DEVICE, AND STORAGE MEDIUM

(71) Applicant: GUANGDONG OPPO MOBILE TELECOMMUNICATIONS CORP., LTD., Dongguan (CN)

(72) Inventors: Jing XU, Dongguan (CN); Bin LIANG, Dongguan (CN)

(21) Appl. No.: 18/751,732

(22) Filed: Jun. 24, 2024

Related U.S. Application Data
(63) Continuation of application No. PCT/CN2021/143899, filed on Dec. 31, 2021.

(51) Int. Cl. H04W 72/231; H04L 1/00; H04L 27/26; H04W 72/0453

(52) U.S. Cl. CPC H04W 72/231; H04L 1/0038; H04L 27/26025; H04W 72/0453

(57) ABSTRACT

Provided is a method for detecting a physical downlink control channel (PDCCH). The method is applicable to a terminal, and includes: performing a PDCCH detection based on a carrier combination, wherein the carrier combination includes one or more carriers. The carrier combination is preconfigured by a higher layer signaling. Performing the PDCCH detection based on the carrier combination includes: performing a PDCCH blind detection based on a PDCCH configuration defined by a network device for the carrier combination.

### CROSS-REFERENCE TO RELATED APPLICATION

This application is a continuation application of International Application No. PCT/CN2021/143899, filed on Dec. 31, 2021, the disclosure of which is incorporated herein by reference in its entirety.

### TECHNICAL FIELD

Embodiments of the present disclosure relate to the field of mobile communications, and in particular, relate to a method and apparatus for detecting a physical downlink control channel (PDCCH), and a method and apparatus for transmitting a PDCCH, a device, and a storage medium.

### BACKGROUND

In evolution of the 5^{th} generation mobile communication system (5G), downlink control information (DCI) is carried in a PDCCH. A user equipment (UE) needs to detect the PDCCH in receiving the DCI.

### SUMMARY

Embodiments of the present disclosure provide a method and apparatus for detecting a PDCCH, and a method and apparatus for transmitting a PDCCH, a device, equipment, and a storage medium.

In some embodiments of the present disclosure, a method for detecting a PDCCH is provided. The method is applicable to a terminal, and includes: performing a PDCCH detection based on a carrier combination, wherein the carrier combination includes one or more carriers.

In some embodiments of the present disclosure, a method for transmitting a PDCCH is provided. The method is applicable to a network device, and includes: transmitting the PDCCH based on a carrier combination, wherein the carrier combination includes one or more carriers.

In some embodiments of the present disclosure, an apparatus for detecting a PDCCH is provided. The apparatus is applicable to a terminal, and includes: a detecting module, configured to perform a PDCCH detection based on a carrier combination, wherein the carrier combination includes one or more carriers.

In some embodiments of the present disclosure, an apparatus for transmitting a PDCCH is provided. The apparatus is applicable to a network device, and includes: a transmitting module, configured to transmit the PDCCH based on a carrier combination, wherein the carrier combination includes one or more carriers.

In some embodiments of the present disclosure, a terminal is provided. The terminal includes: a processor; wherein the processor is configured to perform a PDCCH detection based on a carrier combination, wherein the carrier combination includes one or more carriers.

In some embodiments of the present disclosure, a network device is provided. The network device includes: a transmitter; wherein the transmitter is configured to transmit the PDCCH based on a carrier combination, wherein the carrier combination includes one or more carriers.

In some embodiments of the present disclosure, a non-transitory computer-readable storage medium is provided. The computer-readable storage medium stores one or more computer programs, wherein the one or more computer programs, when loaded and executed by a processor, cause the processor to perform the method for detecting the PDCCH or the method for transmitting the PDCCH.

In some embodiments of the present disclosure, a chip is provided. The chip includes a programmable logical circuit and/or one or more program instructions. The chip, when loading the programmable logical circuit and/or the one or more program instructions, is caused to perform the method for detecting the PDCCH or the method for transmitting the PDCCH.

In some embodiments of the present disclosure, a computer program product or a computer program is provided. The computer program product or a computer program includes one or more computer instructions, wherein the one or more computer instructions are stored in a computer-readable storage medium. The one or more computer instructions, when read from the computer-readable storage medium and executed by a processor, cause the processor to perform the method for detecting the PDCCH or the method for transmitting the PDCCH.

### BRIEF DESCRIPTION OF DRAWINGS

For clearer description of the technical solutions according to the embodiments of the present disclosure, the accompanying drawings required for describing the embodiments are briefly introduced. Apparently, the accompanying drawings in the following description show merely some embodiments of the present disclosure, and those of ordinary skill in the art may still derive other drawings from these accompanying drawings without any creative efforts.

FIG. 1 is a schematic diagram of a mobile communication system according to some embodiments of the present disclosure;

FIG. 2 is a flowchart of a method for detecting a PDCCH according to some embodiments of the present disclosure;

FIG. 3 is a schematic diagram of a plurality of carrier combinations according to some embodiments of the present disclosure;

FIG. 4 is a flowchart of a method for detecting a PDCCH according to some embodiments of the present disclosure;

FIG. 5 is a flowchart of a method for detecting a PDCCH according to some embodiments of the present disclosure;

FIG. 6 is a flowchart of a method for detecting a PDCCH according to some embodiments of the present disclosure;

FIG. 7 is a flowchart of a method for transmitting a PDCCH according to some embodiments of the present disclosure;

FIG. 8 is a flowchart of a method for transmitting a PDCCH according to some embodiments of the present disclosure;

FIG. 9 is a block diagram of an apparatus for detecting a PDCCH according to some embodiments of the present disclosure;

FIG. 10 is a block diagram of an apparatus for transmitting a PDCCH according to some embodiments of the present disclosure;

FIG. 11 is a schematic structural diagram of a terminal according to some embodiments of the present disclosure; and

FIG. 12 is a schematic structural diagram of a network device according to some embodiments of the present disclosure.

### DETAILED DESCRIPTION

To make the objectives, technical solutions, and advantages of the present disclosure clearer, the embodiments of the present disclosure are further described in detail hereinafter with reference to the accompanying drawings.

The network architectures and service scenarios described in the embodiments of the present disclosure are intended to illustrate the technical solutions of the embodiments of the present disclosure more clearly, and are not constructed as limitations of the technical solutions of the embodiments of the present disclosure. Persons of ordinary skill in the art shall understand that with the evolution of the network architectures and emergence of new service scenarios, the similar technical problems are also applicable to the technical solutions of the embodiments of the present disclosure.

Technical knowledge in the present disclosure is introduced and illustrated prior to introduction of the technical solutions according to the present disclosure.

In most scenarios, a resource scheduled by one piece of DCI is limited on a carrier, and a serving cell corresponds to a carrier. In the case that one piece of DCI schedules physical downlink shared channels (PDSCH) and/or physical uplink shared channels (PUSCH) of a plurality of serving cells, resources scheduled by the DCI correspond to a plurality of carriers or cells. On the contrary, a plurality of carriers correspond to one piece of DCI. The embodiments of the present disclosure provide the technical solutions of how to implement the PDCCH detection in the case that a plurality of carriers correspond to one piece of DCI.

FIG. 1 is a schematic diagram of a mobile communication system according to some embodiments of the present disclosure. The mobile communication system includes at least one terminal 10 and at least one access network device 20.

Typically, a plurality of terminals 10 are deployed, and one or more terminals 10 are deployed in a cell managed by each access network device 20. The terminal 10 is various handheld devices with a mobile communication capability, vehicle-mounted devices, wearable devices, computing devices, other processing devices connected to wireless modems, various forms of user equipments (UEs) and mobile stations (MSs), and the like. The devices mentioned above in the embodiments of the present disclosure are collectively referred to as the terminal for convenience of description.

The access network device 20 is a device deployed in the access network and is configured to provide a mobile communication function to the terminal 10. The access network device 20 includes various forms of macro base stations, micro base stations, relay stations, access points, location management function (LMF) entities, and the like. In systems adopting different wireless access technologies, names of devices with a function of the access network device are different, and specifically referred to as a gNodeB or a gNB in a 5^{th} generation new radio (5G NR) system. With the evolution of the communication technologies, the name of the “access network device” is changed. The above devices for providing the mobile communication function to the terminal 10 in the embodiments of the present disclosure are collectively referred to as the access network device for convenience of description. The access network device 20 and the terminal 10 are connected via an air interface, such that the communication including signaling and data interaction is achieved by the connection. A plurality of access network devices 20 are deployed, and two adjacent access network devices 20 communicate with each other in a wired or wireless mode. The terminal 10 is switched between different access network devices 20, that is, connections are established with different access network devices 20.

The “5G NR system” in the embodiments of the present disclosure is also referred to as a 5G system or an NR system, which is understandable by a person skilled in the art. The technical solutions according to the embodiments of the present disclosure are applicable to the 5G NR system and a future system evolved from the 5G NR system.

The terminal 10 is under coverage of a plurality of cells, for example, a cell X and a cell Y. The access network device 20 schedules resources over or in the plurality of carriers or cells using one piece of DCI. As a serving cell corresponds to a carrier, the “serving cell” and the “carrier” are regarded as the same concept in the present disclosure.

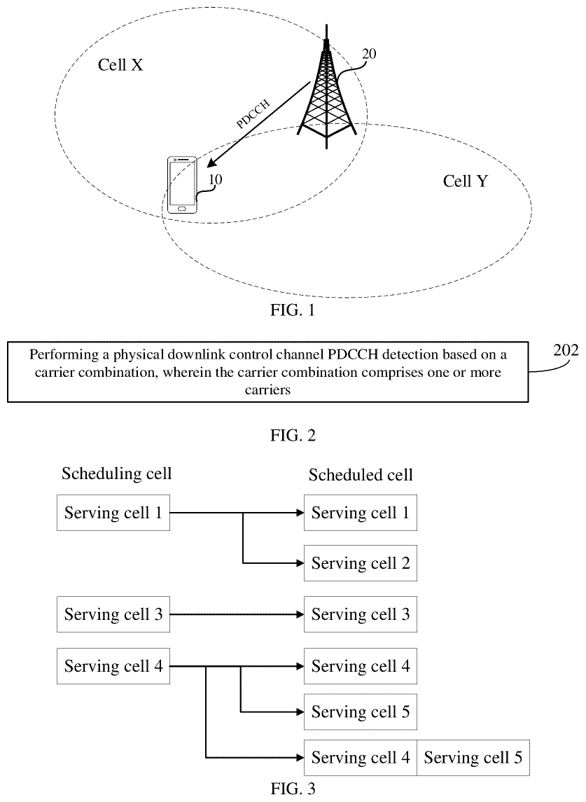

FIG. 2 is a flowchart of a method for detecting a PDCCH according to some embodiments of the present disclosure. The embodiments are described by taking the method being applicable to a terminal as an example. The method includes the following processes.

In S202, a PDCCH detection is performed based on a carrier combination, wherein the carrier combination includes one or more carriers.

The terminal performs the PDCCH detection based on the (scheduled) carrier combination. The carrier combination includes one or more carriers. The plurality of carriers means at least two carriers. All or part of frequency domain resources in the scheduled carrier combination are scheduled by one PDCCH (or one piece of DCI).

Even in the case that the carrier combination includes only one carrier, the carrier is still processed as a carrier combination. One or more carrier combinations may be configured.

In some embodiments, the (scheduled) carrier combination is preconfigured by a higher layer signaling.

In some embodiments, carriers in the same (scheduled) carrier combination are configured with a same subcarrier spacing.

In some embodiments, carriers in the same (scheduled) carrier combination are configured with a same PUCCH group. In the case that various carries in different carrier combinations belong to the same PUCCH group, the various carries in different carrier combinations feed back a hybrid automatic repeat request (HARQ).

Referring to FIG. 3, it is assumed that the scheduling cells include a serving cell 1, a serving cell 2, a serving cell 3, and a serving cell 4, and scheduled cells include a serving cell 1, a serving cell 2, a serving cell 3, a serving cell 4, and a serving cell 5. The scheduling cells are serving cells for issuing the PDCCH, and the scheduled cells are serving cells scheduled by the PDCCH. Serving cells with the same serial number in the scheduling cells and scheduled cells are the same serving cells. The arrow in FIG. 3 represents a scheduling relationship, the serving cell 1 scheduling the serving cell 1 belongs to current-carrier scheduling, and the serving cell 1 scheduling the serving cell 2 belongs to cross-carrier scheduling.

A network device configures five serving cells for the terminal by the higher layer signaling, and the five serving cells belongs to a same cell group. For example, the same cell group belongs to the same master cell group (MCG), or the same cell group belongs to the same secondary cell group (SCG), or the same cell group belongs to the same primary PUCCH group.

Referring to FIG. 3, the scheduled carrier combination is any one of the following six carrier combinations: a carrier combination 1: a serving cell 1; a carrier combination 2: a serving cell 2; a carrier combination 3: a serving cell 3; a carrier combination 4: a serving cell 4; a carrier combination 5: a serving cell 5; and a carrier combination 6: a serving cell 4 and a serving cell 5.

The serving cell 1 is determined as a scheduling cell, and may schedule the serving cell 1 or cross-carrier schedule the serving cell 2. The serving cell 3 is determined as a scheduling cell and may schedule the serving cell 3. The serving cell 4 is determined as a scheduling cell, and may separately schedule the serving cell 4, separately schedule the serving cell 5, or simultaneously schedule the serving cell 4 and the serving cell 5. In the carrier combinations 1 to 5, each carrier combination includes one carrier. The carrier combination 6 includes two carriers.

In summary, in the method according to the embodiments, the PDCCH detection is performed on a per-carrier combination basis, such that the PDCCHs in the plurality of carriers are detected in a scenario of scheduling PDSCHs and/or PUSCHs of a plurality of serving cells by one piece of DCI, and related designs of the PDCCH detection process are applied to the carrier combination to avoid different designs for distinguish the cases of “one piece of DCI scheduling a carrier” and “one piece of DCI scheduling a plurality of carriers” and to reduce the complexity of the communication protocol.

The PDCCH detection process includes the following three parts.

### PDCCH Configuration

The terminal receives the PDCCH configuration, and acquires at least one of a time frequency region, a mapping manner, a DCI format, an aggregation level, and other information of the PDCCH blind detection. Specifically, PDCCH-Config is configured with a series of user-specific parameters for the terminal to receive user-specific control information and group common control information, and the user-specific parameters are separately configured with respect to each bandwidth part (BWP) of each serving cell. The parameters include a core resource set (CORESET) configuration, a search space (Search Space) configuration, a group common control information configuration, a specific transmit power control (TPC) related configuration, a downlink preemption (downlinkPreemption) configuration, an uplink cancellation (uplinkCancellation) configuration, and a search space switching (searchspace switching) related configuration.

### DCI Size Alignment

A new radio (NR) system supports the PDCCH blind detection in the search space sets configured on a network side by the terminal. In the PDCCH blind detection, the terminal does not know format information of the DCI issued by the network device prior to detecting the DCI in the PDCCH, and thus the terminal performs a blind detection on candidate PDCCHs in the search space sets using several fixed DCI sizes. The DCI sizes require to be aligned to reduce the complexity in the PDCCH blind detection by the terminal.

In the case that the terminal is configured with more than three DCI formats scrambled by a cell-radio network temporary identifier (C-RNTI), the number of DCI sizes is three by aligning the DCI sizes. For example, in the case that there are four DCI formats scrambled by the C-RNTI, one of the four DCI formats is supplemented or truncated to cause the DCI format to be the same as the DCI format of one of the other three DCI formats.

In this case, the terminal only performs the blind detection on three DCI sizes in the blind detection process and does not perform the blind detection on each DCI format. The terminal distinguishes different DCI formats with the same DCI size by reading contents in the DCI.

The communication protocol in some practices engages that for a scheduled carrier or cell, the number of DCI sizes is not greater than 4, and the number of DCI sizes scrambled by the C-RNTI is not greater than 3.

### Determination of a PDCCH Detection Capability of the Terminal

The NR protocol further engages the PDCCH detection capability to ensure that the number of detections of the PDCCH configured on the network side is within a capability range of achievable by the terminal and to constraint the PDCCH configuration on the network side. In the case that the blind detection or channel estimation required by the to-be-detected PDCCH configured on the network side beyond the PDCCH detection capability of the terminal, the terminal stops detecting the PDCCH in remaining potential resources.

### With Respect to the PDCCH Configuration

FIG. 4 is a flowchart of a method for detecting a PDCCH according to some embodiments of the present disclosure. The embodiments are described by taking the method being applicable to a terminal as an example. The method includes the following processes.

In S402, a terminal receives a PDCCH configuration corresponding to a carrier combination from a network device.

Referring to FIG. 3, the terminal receives PDCCH configurations respectively configured for six combinations of the serving cells 1 to 5, and serving cells 4 and 5 by the network device. The PDCCH configuration corresponding to the carrier combination is configured with at least one of the time frequency region, the mapping manner, the DCI format, or the aggregation level of the PDCCH blind detection. The PDCCH configuration is defined for a carrier combination. A carrier combination is configured with one or more PDCCH configurations. In the case that a carrier combination is configured with a plurality of PDCCH configurations, the plurality of PDCCH configurations are in one-to-one correspondence with a plurality of BWPs in the carrier combination.

In some embodiments, the PDCCH configuration includes at least one of: PDCCH configuration information (PDCCH Config) corresponding to the carrier combination; a control resource set (ControlResourceSet or CORESET) corresponding to the carrier combination; or a search space set (SearchSpaceSet or SearchSpace) corresponding to the carrier combination.

In the embodiments, the network device defines a first PDCCH configuration for the serving cell 1, a second PDCCH configuration for the serving cell 2, a third PDCCH configuration for the serving cell 3, a fourth PDCCH configuration for the serving cell 4, a fifth PDCCH configuration for the serving cell 5, and a sixth PDCCH configuration for the carrier combination of the serving cells 4 and 5.

Specifically, the network device configures first PDCCH Config, first SearchSpace and first ControlResourceSet for the serving cell 1; second PDCCH-Config, second SearchSpace and second ControlResourceSet for the serving cell 2, . . . , and sixth PDCCH-Config, sixth SearchSpace and sixth ControlResourceSet for the carrier combination of the serving cells 4 and 5.

In some embodiments, the SearchSpace and the ControlResourceSet are two information domains in the PDCCH Config. In some embodiments, the PDCCH configuration includes all information domains of the PDCCH Config. In some embodiments, the PDCCH configuration only includes the CORESET and/or the SearchSpace, that is, part of the information domains of the PDCCH Config. In some embodiments, the PDCCH configuration includes the CORESET, the SearchSpace, and some newly added information domains or information elements, which are not limited in the embodiments of the present disclosure.

In some embodiments, the terminal receives a cross-carrier configuration corresponding to the carrier combination from the network device. The cross-carrier configuration includes a value of a carrier indicator field (CIF) corresponding to the carrier combination.

In the example shown in FIG. 3, the network device configures a cross-carrier configuration for the serving cell 1, the serving cell 2, the serving cell 4, the serving cell 5, and the carrier combination of the serving cells 4 and 5. For example, the cross-carrier configuration is a cross-carrier scheduling configuration (CrossCarrierSchedulingConfig). The network device configures a first cross-carrier configuration for the serving cell 1, a second cross-carrier configuration for the serving cell 2, . . . , and a fifth cross-carrier configuration for the carrier combination of the serving cells 4 and 5.

Specifically, the network device configures first CrossCarrierSchedulingConfig for the serving cell 1, second CrossCarrierSchedulingConfig for the serving cell 2, . . . , and fifth CrossCarrierSchedulingConfig for the carrier combination of the serving cells 4 and 5.

In the cross-carrier configuration (represented by CrossCarrierSchedulingConfig in some embodiments), each of the serving cells 1, 2, 3, 4 and 5, and the carrier combination of the serving cells 4 and 5 is configured with a value of the CIF, and a carrier combination corresponds to a value of the CIF. As shown in the example shown in FIG. 3, the specific configuration results are as follows.

TABLE 1
examples of cross-carrier configurations

| Serving cell ID | CrossCarrierSchedulingConfig |
|---|---|
| Serving cell 1 | own SEQUENCE { cif-Presence }, |
| Serving cell 2 | Other |
| | SEQUENCE { |
| | schedulingCellId serving cell 1, |
| | cif-InSchedulingCell 1 |
| | } |
| Serving cell 4 | own SEQUENCE { cif-Presence }, |
| Serving cell 5 | Other |
| | SEQUENCE { |
| | schedulingCellId serving cell 4, |
| | cif-InSchedulingCell 1 |
| | } |
| Serving cells 4 and 5 | other |
| | SEQUENCE { |
| | schedulingCellId serving cell 4, |
| | cif-InSchedulingCell 2 |
| | } |

Values of the CIF corresponding to the serving cell 1, the serving cell 2, the serving cell 4, the serving cell 5 are all 1, and the value of the CIF corresponding to the carrier combination of the serving cells 4 and 5 is 2.

In S404, the terminal performs a PDCCH blind detection based on a PDCCH configuration defined by a network device for the carrier combination.

In the embodiments, the terminal performs the PDCCH detection on corresponding time frequency resources based on the PDCCH configurations corresponding to six combinations of the scheduled cells: the serving cell 1, the serving cell 2, the serving cell 3, the serving cell 4, the serving cell 5, and the serving cells 4 and 5.

The control resource set is configured with a frequency domain position and a time frequency length of the candidate PDCCH, and the search resource set is configured with a time domain position of the candidate PDCCH.

In the case that the scheduled carrier combination includes the carrier combination 6 of the serving cells 4 and 5, the PDCCH blind detection is performed based on the PDCCH configuration for the carrier combination 6.

In S406, a scheduled carrier combination is determined based on a value of a CIF carried in the PDCCH in the case that the PDCCH blind detection is successful.

In some embodiments, for any of the five carrier combinations of the serving cell 1, the serving cell 2, the serving cell 3, the serving cell 4, the serving cell 5, and the carrier combination of the serving cells 4 and 5, the PDCCH detection is performed based on the PDCCH configuration corresponding to the scheduled carrier combination, and the scheduled carrier combination is determined by reading the value of the CIF. By taking the cross-carrier configurations in Table 1 as an example, assuming that the terminal performs the PDCCH detection on the serving cell 4 based on the PDCCH configuration corresponding to the carrier combination of the serving cells 4 and 5, the terminal determines whether the PDCCH (or DCI) schedules the carrier combination of the serving cells 4 and 5 by reading the value of the CIF in the case that the PDCCH blind detection is successful, that is, a cyclic redundancy check (CRC) is successful. In the case that the value of the CIF is 2, the PDCCH schedules the carrier combination of the serving cells 4 and 5.

Illustratively, in the case that the carrier combination includes at least two carriers, the terminal further determines the scheduling carrier in the carrier combination. The scheduling carrier is all or part of carriers in the carrier combination, or one carrier in the carrier combination.

In a first case, the frequency domain resource indicated by the DCI for scheduling the carrier combination of the serving cells 4 and 5 includes part or all frequency domain resources of the serving cell 4 and part or all frequency domain resources of the serving cell 5.

In a second case, the frequency domain resource indicated by the DCI for scheduling the carrier combination of the serving cells 4 and 5 includes part or all frequency domain resources of the serving cell 4 and part or all frequency domain resources of the serving cell 5, only includes part or all frequency domain resources of the serving cell 4, or only includes part or all frequency domain resources of the serving cell 5.

The above two manners are determined by the network configuration, taking into account effects of PDCCH detection capability allocation and DCI transmission efficiency. In the first case, separately scheduling the serving cell 4, separately scheduling the serving cell 5, and scheduling the carrier combination of the serving cells 4 and 5 are used independently to avoid redundant information in the DCI and reduce the transmission efficiency of the DCI. In the second case, the PDCCH of the carrier combination of the serving cells 4 and 5 is scheduled, or the serving cell 4 or 5 is separately scheduled. That is, the PDCCH of the serving cells 4 and 5 is separately scheduled without any configuration, such that the number of scheduled carrier combinations is reduced, and the PDCCH detection capability allocation is further affected.

The above manner is also limited by engagement of the communication protocol, and detailed communication protocol constraints that only the first case is allowed.

In summary, in the method according to the embodiments, the PDCCH detection is performed on a per-carrier combination basis, such that the PDCCHs scheduling one or more carriers are detected on the per-carrier combination basis in a scenario of scheduling PDSCHs and/or PUSCHs of a plurality of serving cells by one piece of DCI, and related designs of the PDCCH detection process are applied to the carrier combination to avoid different designs for distinguish the cases of “one piece of DCI scheduling a carrier” and “one piece of DCI scheduling a plurality of carriers” and to reduce the complexity of the communication protocol.

In the method according to the embodiments, by configuring the PDCCH on a per-carrier combination basis, differential configurations are achieved depending on actual scheduling cases, such that the PDCCH detection capability allocation is balanced in different carrier combinations, and the PDCCH transmission efficiency is improved.

In the method according to the embodiments, the carriers in the same carrier combination are configured with a same subcarrier spacing, and the carriers in the same carrier combination are configured with a same PUCCH group, such that information domains related to time domain resource allocation (TDRA) and PUCCH resources in the same DCI are efficiently shared.

### With Respect to the DCI Size Alignment

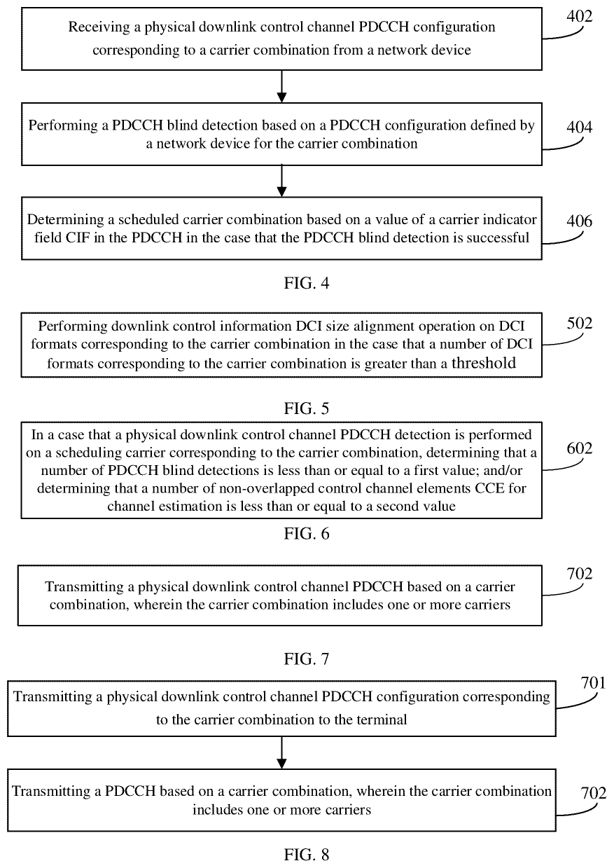

FIG. 5 is a flowchart of a method for detecting a PDCCH according to some embodiments of the present disclosure. The embodiments are described by taking the method being applicable to a terminal as an example. The method includes the following processes.

In S502, a DCI size alignment operation is performed on DCI formats corresponding to the carrier combination in the case that the number of DCI formats corresponding to the carrier combination is greater than a threshold.

In some embodiments: the threshold is 3 for pieces of DCI scrambled by the C-RNTI; and the threshold is 4 for all pieces of DCI.

The terminal performs the DCI size alignment operation on a plurality of DCI formats of the same scheduled carrier combination. As the DCI for scheduling the serving cell 4, the DCI for scheduling the serving cell 5, and the DCI for scheduling the carrier combination of the serving cells 4 and 5 belong to different carrier combinations, the DCI size alignment operation is not required to be performed on different carrier combinations.

For scheduled carrier combination 1: the serving cell 4, the DCI format 0_0, the DCI format 0_1, the DCI format 0_2, the DCI format 1_0, the DCI format 1_1, and the DCI format 1_2 are configured on the network side, and the number of DCI sizes is greater than 3. Thus, the terminal performs the DCI size alignment operation until the number of DCI sizes is not greater than 3.

For example, for scheduled carrier combination 6: the carrier combination of the serving cells 4 and 5, the DCI format 0_x and the DCI format 1_x are configured on the network side, and x is a positive integer greater than 2. As the number of DCI sizes is 2 and is not greater than 3, the terminal is not required to perform the DCI size alignment operation on the DCI format 0_x and the DCI format 1_x and is not required to perform the DCI size alignment operation with other carrier combinations. Specifically, the terminal is not required to perform the DCI size alignment operation with the DCI formats in the carrier combination 1.

In summary, in the method according to the embodiments, the DCI size alignment operation is performed on a per-carrier combination basis, and the DCI size alignment operation on the DCI formats of “one piece of DCI scheduling a carrier” and “one piece of DCI scheduling a plurality of carriers” is avoided, such that the operations on the terminal side are simplified.

### With Respect to the PDCCH Detection Capability of the Terminal

FIG. 6 is a flowchart of a method for detecting a PDCCH according to some embodiments of the present disclosure. The embodiments are described by taking the method being applicable to a terminal as an example. The method includes the following processes.

In S602, in the case that the PDCCH detection is performed on a scheduling carrier corresponding to the carrier combination, the number of PDCCH blind detections is determined to be less than or equal to a first value min(M_{PDCCH}^{max,slot,μ}, M_{PDCCH}^{total,slot,μ}); and/or the number of non-overlapped control channel elements (CCEs) channel estimation is determined to be less than or equal to a second value min(C_{PDCCH}^{max,slot,μ}, C_{PDCCH}^{total,slot,μ}).

In some embodiments, M_{PDCCH}^{max,slot,μ} represents a maximum number of monitored PDCCH candidates in the carrier combination, and M_{PDCCH}^{total,slot,μ} represents a total number of monitored PDCCH candidates of a parameter set of the scheduling carrier corresponding to the carrier combination, wherein the parameter set is a parameter set corresponding to a subcarrier spacing parameter μ.

In the first value and the second value, min (A, B) represents a less value in A and B.

In some embodiments, values of M_{PDCCH}^{max,slot,μ} are shown in Table 2.

TABLE 2

| | Maximum number of monitored |
|---|---|
| | PDCCH candidates per slot and |
| μ | per serving cell M_{PDCCH}^{max, slot, μ} |
| 0 | 44 |
| 1 | 36 |
| 2 | 22 |
| 3 | 20 |

In some embodiments, M_{PDCCH}^{max,slot,μ} is equal to:

$${N}_{cells}^{cap} \cdot {M}_{PDCCH}^{max , slot , μ} \cdot ( {N}_{cells}^{DL , μ} ) / {\sum }_{j = 0}^{3} {N}_{cells}^{DL , j} .$$

N_{cells}^{cap} represents a PDCCH detection capability reported by the terminal, N_{cells}^{DL,j} is determined based on the number of carrier combinations with the parameter set of the scheduling carrier being j, and N_{cells}^{DL,μ} is determined based on the number of carrier combinations with the parameter set of the scheduling carrier being μ. Σ is a summation symbol.

In some embodiments, C_{PDCCH}^{max,slot,μ} represents a maximum number of the non-overlapped CCEs for channel estimation in the carrier combination, and C_{PDCCH}^{total,slot,μ} represents a total number of non-overlapped CCEs for the channel estimation of a parameter set corresponding to the carrier combination, wherein the parameter set is a parameter set corresponding to a subcarrier spacing parameter μ.

In some embodiments, values of C_{PDCCH}^{max,slot,μ} are shown in Table 3.

TABLE 3

| | Maximum number of non- |
|---|---|
| | overlapped CCEs per slot and |
| μ | per serving cell C_{PDCCH}^{max, slot, μ} |
| 0 | 56 |
| 1 | 56 |
| 2 | 48 |
| 3 | 32 |

In some embodiments, C_{PDCCH}^{total,slot,μ} is determined by:

$${C}_{PDCCH}^{total , slot , μ} = ⌊ {N}_{cells}^{c a p} \cdot {C}_{PDCCH}^{max , slot , μ} \cdot ( {N}_{cells}^{DL , μ} ) / {\sum }_{j = 0}^{3} {N}_{cells}^{DL , j} ⌋ .$$

In some embodiments, N_{cells}^{cap} represents a PDCCH detection capability reported by the terminal, N_{cells}^{DL,j} is determined based on the number of carrier combinations with the parameter set of the scheduling carrier being j, and N_{cells}^{DL,μ} is determined based on the number of carrier combinations with the parameter set of the scheduling carrier being μ.

In some embodiments, the terminal reports the PDCCH detection capability N_{cells}^{cap} to the network device prior to S602.

A First Method (without an Adjustment Coefficient)

In some embodiments, assuming that the number of carrier combinations with the parameter set of the scheduling carrier being 0 (μ=0) is N_{cells}^{DL,0}, the number of carrier combinations with the parameter set of the scheduling carrier being 1 is N_{cells}^{DL,1}, the number of carrier combinations with the parameter set of the scheduling carrier being 2 is N_{cells}^{DL,2}, and the number of carrier combinations with the parameter set of the scheduling carrier being 3 is N_{cells}^{DL,3}, then

$${\sum }_{j = 0}^{3} {N}_{cells}^{DL , j} = {N}_{cells}^{DL , 0} + {N}_{cells}^{DL , 1} + {N}_{cells}^{DL , 2} + {N}_{cells}^{DL , 3}$$

in the case that a count value of each number of the carrier combination is 1 (that is, without the adjustment coefficient).

As shown in FIG. 3, it is assumed that the carrier combination includes six scheduled carrier combinations, that is, the serving cells 1, 2, 3, 4 and 5, and 4+5. In conjunction with an allocation rule of PDCCH detection capability, by taking the FIG. 3 as an example, u configured for activating the BWPs in the serving cells 1, 2 and 3 is 0, u configured for activating the BWPs in the serving cells 4 and 5 is 1, and the PDCCH detection capability N_{cells}^{cap} reported by the terminal is 2, then with respect to the serving cells 1, 2 and 3, the number of PDCCH blind detections is less than or equal to min(M_{PDCCH}^{max,slot,μ}, M_{PDCCH}^{total,slot,μ}) and the maximum number of non-overlapped CCEs for the channel estimation is less than or equal to min(C_{PDCCH}^{max,slot,μ}, C_{PDCCH}^{total,slot,μ}).

With respect to the serving cell 1, the serving cell 2, and the serving cell 3 (three carrier combinations) with u being 0, for details about M_{PDCCH}^{max,slot,μ} and C_{PDCCH}^{max,slot,μ}, reference may be made to Table 2 and Table 3 respectively. M_{PDCCH}^{total,slot,μ} and C_{PDCCH}^{total,slot,μ} are determined by:

$${M}_{PDCCH}^{t otal , slot , μ} = ⌊ 2 \cdot {M}_{PDCCH}^{max , slot , μ} \cdot 3 / 6 ⌋ ;$$

$${C}_{PDCCH}^{t o t a 1 , s 1 o t , μ} = ⌊ 2 \cdot {C}_{PDCCH}^{max , s 1 o t , μ} \cdot 3 / 6 ⌋ .$$

Count values of the serving cells 1 to 3 are all 1, a sum of the count values of the three serving cells N_{cells}^{DL},μ is 3, and a sum of the count values of six carrier combinations

$${\sum }_{j = 0}^{3} {N}_{cells}^{DL , j}$$

is 6.

With respect to the serving cell 4, the serving cell 5, and serving cells 4 and 5 (three carrier combinations), the number of PDCCH blind detections is less than or equal to min(M_{PDCCH}^{max,slot,μ}, M_{PDCCH}^{total,slot,μ}), and the maximum number of non-overlapped CCEs for the channel estimation is less than or equal to min(C_{PDCCH}^{max,slot,μ}, C_{PDCCH}^{total,slot,μ}) For details about M_{PDCCH}^{max,slot,μ} and C_{PDCCH}^{max,slot,μ}, reference may be made to Table 2 and Table 3 respectively. M_{PDCCH}^{total,slot,μ} and C_{PDCCH}^{total,slot,μ} are determined by:

$${M}_{PDCCH}^{total , slot , μ} = ⌊ 2 \cdot {M}_{PDCCH}^{max , slot , μ} \cdot 3 / 6 ⌋ ;$$

$${C}_{PDCCH}^{total , slot , μ} = ⌊ 2 \cdot {C}_{PDCCH}^{max , slot , μ} \cdot 3 / 6 ⌋ .$$

Count values of the serving cells 4 to 6 are all 1, a sum of the count values of the three serving cells N_{cells}^{DL,μ} is 3, and a sum of the count values of six carrier combinations

$${\sum }_{j = 0}^{3} {N}_{cells}^{DL , j}$$

is 6.
A Second Method (with an Adjustment Coefficient)

Based on the first method, an adjustment coefficient is added for each carrier in demarcating the total capability of the plurality of carriers. That is, the count value of each carrier combination in calculating N_{cells}^{DL,μ} is 1 in the first method, and the count value of each carrier combination in calculating N_{cells}^{DL,μ} is equal to times the adjustment coefficient in the second method. The adjustment coefficient is a non-negative number.

In some embodiments, N_{cells}^{DL,j} is determined based on the number of at least one carrier combination with the parameter set of the scheduling carrier being j and an adjustment coefficient corresponding to the at least one carrier combination. The adjustment coefficient is predefined by a communication protocol or configured by the network device (higher layer signaling).

In the case of the adjustment coefficient, assuming that the number of carrier combinations with the parameter set of the scheduling carrier being 0 to 3 is N, and an adjustment coefficient corresponding to i^{th} carrier combination is αᵢ, then:

$${\sum }_{j = 0}^{3} {N}_{cells}^{DL , j} = {\sum }_{i = 0}^{N} 1 * {α}_{i} .$$

Assuming that the number of carrier combinations with the parameter set of the scheduling carrier being μ is K, and an adjustment coefficient corresponding to i^{th} carrier combination in the K carrier combinations is αᵢ, then:

$${N}_{cells}^{DL , μ} = {\sum }_{i = 0}^{K} 1 * {α}_{i} .$$

As an adjustment coefficient of the serving cell 4 is 0.8, an adjustment coefficient of the serving cell 5 is 0.8, and an adjustment coefficient of the serving cells 4 and 5 is 0.4, an adjustment coefficient of the serving cell 1, 2 or 3 is 1.

As shown in FIG. 3, it is assumed that μ configured for activating the BWPs in the serving cells 1, 2 and 3 is 0, μ configured for activating the BWPs in the serving cells 4 and 5 is 1, and the PDCCH detection capability N_{cells}^{cap} cells reported by the terminal is 2. Thus, with respect to the serving cells 1, 2 and 3, the number of PDCCH blind detections is less than or equal to min(M_{PDCCH}^{max,slot,μ}, M_{PDCCH}^{total,slot,μ}) and the maximum number of non-overlapped CCEs for the channel estimation is less than or equal to min(C_{PDCCH}^{max,slot,μ}, C_{PDCCH}^{total,slot,μ}).

With respect to the serving cell 1, the serving cell 2, and the serving cell 3 (three carrier combinations) with μ being 0, for details about M_{PDCCH}^{max,slot,μ} and C_{PDCCH}^{max,slot,μ}, reference may be made to Table 2 and Table 3 respectively. M_{PDCCH}^{total,slot,μ} and C_{PDCCH}^{total,slot,μ} are determined by:

$${M}_{PDCCH}^{total , slot , μ} = ⌊ 2 \cdot {M}_{PDCCH}^{max , slot , μ} \cdot ( 1 + 1 + 1 ) / ( 1 + 1 + 1 + 0. 8 + 0.8 + 0.4 ) ⌋ ;$$

$${C}_{PDCCH}^{total , slot , μ} = ⌊ 2 \cdot {C}_{PDCCH}^{max , slot , μ} \cdot ( 1 + 1 + 1 ) / ( 1 + 1 + 1 + 0. 8 + 0.8 + 0.4 ) ⌋ .$$

Count values of the serving cells 1 to 3 are all 1, a count value of the serving cell 4 is 0.8, a count value of the serving cell 5 is 0.8, and a count value of the serving cells 4 and 5 is 0.4. In this case, a sum of the count values of the serving cells 1 to 3 N_{cells}^{DL,μ} is 3, that is, (1+1+1)=3, and a sum of the count values of six carrier combinations

$${\sum }_{j = 0}^{3} {N}_{cells}^{DL , j}$$

is (1+1+1+0.8+0.8+0.4)=5.

With respect to the serving cell 4, the serving cell 5, and serving cells 4 and 5 (three carrier combinations), the number of PDCCH blind detections is less than or equal to min(M_{PDCCH}^{max,slot,μ}, M_{PDCCH}^{total,slot,μ}), and the maximum number of non-overlapped CCEs for the channel estimation is less than or equal to min(C_{PDCCH}^{max,slot,μ}, C_{PDCCH}^{total,slot,μ}) For details about M_{PDCCH}^{max,slot,μ} and C_{PDCCH}^{max,slot,μ}, reference may be made to Table 2 and Table 3 respectively. C_{PDCCH}^{max,slot,μ} and C_{PDCCH}^{max,slot,μ} are determined by:

$${M}_{PDCCH}^{total , slot , μ} = ⌊ 2 \cdot {M}_{PDCCH}^{max , slot , μ} \cdot ( 0.8 + 0.8 + 0 \text{.4} ) / ( 1 + 1 + 1 + 0. 8 + 0.8 + 0.4 ) ⌋ ;$$

$${C}_{PDCCH}^{total , slot , μ} = ⌊ 2 \cdot {C}_{PDCCH}^{max , slot , μ} \cdot ( 0.8 + 0.8 + 0 \text{.4} ) / ( 1 + 1 + 1 + 0. 8 + 0.8 + 0.4 ) ⌋ .$$

Count values of the serving cells 1 to 3 are 1, a count value of the serving cell 4 is 0.8, a count value of the serving cell 5 is 0.8, and a count value of the serving cells 4 and 5 is 0.4. In this case, a sum of the count values of the serving cell 4, the serving cell 5, and the serving cells 4 and 5 (three carrier combinations) N_{cells}^{DL,μ} is 2, that is, 0.8+0.8+0.4=2, and a sum of the count values of six carrier combinations

$${\sum }_{j = 0}^{3} {N}_{cells}^{DL , j}$$

is (1+1+1+0.8+0.8+0.4)=5.

In summary, in the method according to the embodiments, the PDCCH detection capability of the terminal is determined on a per-carrier combination basis, such that more accurate PDCCH detection capability is determined in the scenario of carrier combinations.

In the method according to the embodiments, the adjustment coefficient is added in the plurality of carrier combinations, such that the more accurate PDCCH detection capability is determined based on the adjustment coefficient in the case that the carrier combination includes at least two carriers, and inaccurate PDCCH detection capability due to unreasonably several sums of the same serving cell in calculating the sum of the carrier combination is avoided.

FIG. 7 is a flowchart of a method for transmitting a PDCCH according to some embodiments of the present disclosure. The embodiments are described by taking the method being applicable to a network device as an example. The method includes the following processes.

In S702, a PDCCH is transmitted based on a carrier combination, wherein the carrier combination includes one or more carriers.

The network device transmits the PDCCH based on the (scheduled) carrier combination. The carrier combination includes one or more carriers. The plurality of carriers indicate at least two carriers. All or part of frequency domain resources in the scheduled carrier combination are scheduled by one PDCCH (or one piece of DCI).

Even if the carrier combination only includes one carrier, the carrier is treated as a carrier combination for processing.

In some embodiments, the (scheduled) carrier combination is preconfigured by a higher layer signaling.

In some embodiments, carriers in the same (scheduled) carrier combination are configured with same subcarrier spacing.

In some embodiments, carriers in the same (scheduled) carrier combination are configured with a same PUCCH group.

In some embodiments, as shown in FIG. 8, the method further includes the following processes.

In S701, a PDCCH configuration corresponding to the carrier combination is transmitted to the terminal.

The PDCCH configuration corresponding to the carrier combination is configured with at least one of the time frequency region, the mapping manner, the DCI format, or the aggregation level of the PDCCH blind detection. The PDCCH configuration is defined for a carrier combination or a single carrier combination. A carrier combination is configured with one or more PDCCH configurations. In the case that a carrier combination is configured with a plurality of PDCCH configurations, the plurality of PDCCH configurations are in one-to-one correspondence with a plurality of BWPs in the carrier combination.

In some embodiments, the PDCCH configuration includes at least one of: PDCCH Config corresponding to the carrier combination; ControlResourceSet or CORESET corresponding to the carrier combination; or SearchSpaceSet or SearchSpace corresponding to the carrier combination.

In some embodiments, the SearchSpace and the ControlResourceSet are two information domains in the PDCCH Config. In some embodiments, the PDCCH configuration includes all information domains of the PDCCH Config. In some embodiments, the PDCCH configuration only includes the CORESET and/or the SearchSpace, that is, part of the information domains of the PDCCH Config. In some embodiments, the PDCCH configuration includes the CORESET, the SearchSpace, and some newly added information domains or information elements, which are not limited in the embodiments of the present disclosure.

In some embodiments, the method further includes: transmitting a cross-carrier configuration corresponding to the carrier combination. The cross-carrier configuration includes the value of the CIF corresponding to the carrier combination.

In some embodiments, the method further includes: performing a downlink control information DCI size alignment operation on DCI formats corresponding to the carrier combination in the case that the number of DCI formats corresponding to the carrier combination is greater than a threshold. In some embodiments, the threshold is 3 for pieces of DCI scrambled by the C-RNTI; and the threshold is 4 for all pieces of DCI.

In some embodiments, the network device determines that the number of PDCCH blind detections is less than or equal to min(M_{PDCCH}^{max,slot,μ}, M_{PDCCH}^{total,slot,μ}) in the case that the PDCCH detection is performed on a scheduling carrier corresponding to the carrier combination.

M_{PDCCH}^{max,slot,μ} represents a maximum number of monitored PDCCH candidates in the carrier combination, and M_{PDCCH}^{total,slot,μ} represents a total number of monitored PDCCH candidates of a parameter set of the scheduling carrier corresponding to the carrier combination, wherein the parameter set is a parameter set corresponding to a subcarrier spacing parameter μ.

In some embodiments, M_{PDCCH}^{max,slot,μ} is equal to:

$${N}_{cells}^{cap} \cdot {M}_{P D C C H}^{max , slot , μ} \cdot ( {N}_{cells}^{DL , μ} ) / {\sum }_{j = 0}^{3} {N}_{cells}^{DL , j} .$$

N_{cells}^{cap} represents a PDCCH detection capability reported by the terminal, N_{cells}^{DL,j} is determined based on the number of carrier combinations with the parameter set of the scheduling carrier being j, and N_{cells}^{DL,μ} is determined based on the number of carrier combinations with the parameter set of the scheduling carrier being μ.

In some embodiments, the network device determines that a maximum number of non-overlapped control channel elements CCEs for channel estimation is less than or equal to min(C_{PDCCH}^{max,slot,μ}, C_{PDCCH}^{total,slot,μ}) in the case that the PDCCH detection is performed on a scheduling carrier corresponding to the carrier combination.

C_{PDCCH}^{max,slot,μ} represents a maximum number of the non-overlapped CCEs for the channel estimation in the carrier combination, and C_{PDCCH}^{total,slot,μ} represents a total number of non-overlapped CCEs for the channel estimation of a parameter set corresponding to the carrier combination, wherein the parameter set is a parameter set corresponding to a subcarrier spacing parameter μ.

In some embodiments, C_{PDCCH}^{total,slot,μ} is determined by:

$${C}_{P D C C H}^{total , slot , μ} = ⌊ {N}_{cells}^{c a p} \cdot {C}_{P D C C H}^{max , slot , μ} \cdot ( {N}_{cells}^{DL , μ} ) / {\sum }_{j = 0}^{3} {N}_{cells}^{DL , j} ⌋ .$$

N_{cells}^{cap} represents a PDCCH detection capability reported by the terminal, and N_{cells}^{DL,j} is determined based on the number of carrier combinations with the parameter set of the scheduling carrier being j.

In some embodiments, the method further includes: receiving, by the network device, the PDCCH detection capability N_{cells}^{cap} reported by the terminal.

In some embodiments, N_{cells}^{DL,j} is determined based on the number of carrier combinations with the parameter set of the scheduling carrier being j, or N_{cells}^{cap}, is determined based on the number of carrier combinations with the parameter set of the scheduling carrier being and an adjustment coefficient corresponding to the carrier combinations. The adjustment coefficient is predefined by a communication protocol or configured by a higher layer signaling. In some embodiments, the adjustment coefficient is a non-negative number.

In some embodiments, assuming that the number of carrier combinations with the parameter set of the scheduling carrier being 0 (μ=0) is N_{cells}^{DL,0}, the number of carrier combinations with the parameter set of the scheduling carrier being 1 is N_{cells}^{DL,1}, the number of carrier combinations with the parameter set of the scheduling carrier being 2 is N_{cells}^{DL,2}, and the number of carrier combinations with the parameter set of the scheduling carrier being 3 is N_{cells}^{DL,3}, then

$${\sum }_{j = 0}^{3} {N}_{cells}^{DL , j} = {N}_{cells}^{DL , 0} + {N}_{cells}^{DL , 1} + {N}_{cells}^{DL , 2} + {N}_{cells}^{DL , 3}$$

in the case that a count value of each number of the carrier combination is 1 (that is, without the adjustment coefficient).

In some embodiments, N_{cells}^{DL,j} is determined based on the number of at least one carrier combination with the parameter set of the scheduling carrier being j and an adjustment coefficient corresponding to the at least one carrier combination. The adjustment coefficient is predefined by a communication protocol or configured by the network device (higher layer signaling).

In the case of the adjustment coefficient, assuming that the number of carrier combinations with the parameter set of the scheduling carrier being 0 to 3 is N, and an adjustment coefficient corresponding to i^{th} carrier combination is αᵢ, then:

$${\sum }_{j = 0}^{3} {N}_{cells}^{DL , j} = {\sum }_{i = 0}^{N} 1 * {α}_{i} .$$

Assuming the number of carrier combinations with the parameter set of the scheduling carrier being μ is K, and an adjustment coefficient corresponding to i^{th} carrier combination in the K carrier combinations is αᵢ, then:

$${N}_{cells}^{DL , μ} = {\sum }_{i = 0}^{K} 1 * {α}_{i} .$$

In summary, in the method according to the embodiments, the PDCCH is transmitted on a per-carrier combination basis, such that the PDCCHs in the plurality of carriers are issued in a scenario of scheduling PDSCHs and/or PUSCHs of a plurality of serving cells by one piece of DCI, and related designs of the PDCCH detection process are applied to the carrier combination to avoid different designs for distinguish the cases of “one piece of DCI scheduling a carrier” and “one piece of DCI scheduling a plurality of carriers” and to reduce the complexity of the communication protocol.

In the method according to the embodiments, by configuring the PDCCH on a per-carrier combination basis, differential configurations are achieved depending on actual scheduling cases, such that the PDCCH detection capability allocation is balanced in different carrier combinations, and the PDCCH transmission efficiency is improved.

In the method according to the embodiments, the carriers in the same carrier combination are configured with same subcarrier spacing, and the carriers in the same carrier combination are configured with a same PUCCH group, such that information domains related to TDRA and PUCCH resources in the same DCI are efficiently shared.

In the method according to the embodiments, the DCI size alignment operation is performed on a per-carrier combination basis, and the DCI size alignment operation on the DCI formats of “one piece of DCI scheduling a carrier” and “one piece of DCI scheduling a plurality of carriers” is avoided, such that the operations on the terminal side are simplified.

In summary, in the method according to the embodiments, the PDCCH detection capability of the terminal is determined on a per-carrier combination basis, such that more accurate PDCCH detection capability is determined in the scenario of carrier combinations.

In the method according to the embodiments, the adjustment coefficient is added in the plurality of carrier combinations, such that the more accurate PDCCH detection capability is determined based on the adjustment coefficient in the case that the carrier combination includes at least two carriers, and inaccurate PDCCH detection capability due to unreasonably several sums of the same serving cell in calculating the sum of the carrier combination is avoided.

It should be noted that in the embodiments of the present disclosure, the “serving cell” and the “carrier” are regarded as the same concept and are exchangeable. In the embodiments of the present disclosure, the carrier combination includes one or more carriers, and the plurality of carriers indicate at least two carriers.

It should be noted that variables in the above formula can be represented by other characters as long as the meaning is unchanged, and the representation of variables is not limited in the present disclosure.

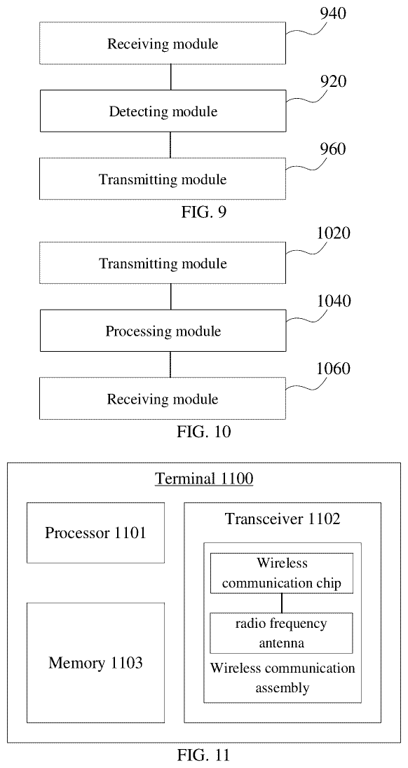

FIG. 9 is a block diagram of an apparatus for detecting a PDCCH according to some embodiments of the present disclosure. The apparatus for detecting the PDCCH is achieved as all or part of the terminal. The apparatus includes: a detecting module 920, configured to perform PDCCH detection based on a carrier combination, wherein the carrier combination includes one or more carriers.

In some embodiments, the carrier combination is preconfigured by a higher layer signaling.

In some embodiments, the one or more carriers in the carrier combination are configured with same subcarrier spacing.

In some embodiments, the one or more carriers in the carrier combination are configured with a same PUCCH group.

In some embodiments, the detecting module 920 is further configured to: perform a PDCCH blind detection based on a PDCCH configuration defined by a network device for the carrier combination.

In some embodiments, the apparatus further includes: a receiving module 940, configured to receive the PDCCH configuration corresponding to the carrier combination from the network device.

In some embodiments, the PDCCH configuration corresponding to the carrier combination includes at least one of: PDCCH configuration information corresponding to the carrier combination; a control resource set corresponding to the carrier combination; or a search space set corresponding to the carrier combination.

In some embodiments, the detecting module 920 is further configured to: determine a scheduled carrier combination based on a value of a carrier indicator field CIF carried in the PDCCH in the case that the PDCCH blind detection is successful.

In some embodiments, the apparatus further includes: the receiving module 940, configured to receive a cross-carrier configuration corresponding to the carrier combination from the network device, wherein the cross-carrier configuration includes the value of the CIF corresponding to the carrier combination.

In some embodiments, the detecting module 920 is further configured to: perform a downlink control information DCI size alignment operation on DCI formats corresponding to the carrier combination in the case that the number of DCI formats corresponding to the carrier combination is greater than a threshold. In some embodiments, the threshold is 3 for pieces of DCI scrambled by the C-RNTI, and the threshold is 4 for all pieces of DCI.

In some embodiments, the detecting module 920 is further configured to: determine that the number of PDCCH blind detections is less than or equal to min(M_{PDCCH}^{max,slot,μ}, M_{PDCCH}^{total,slot,μ}) in the case that the PDCCH detection is performed on a scheduling carrier corresponding to the carrier combination.

M_{PDCCH}^{max,slot,μ} represents a maximum number of monitored PDCCH candidates in the carrier combination, M_{PDCCH}^{total,slot,μ} represents a total number of monitored PDCCH candidates of a parameter set of the scheduling carrier corresponding to the carrier combination, and the parameter set is a parameter set corresponding to a subcarrier spacing parameter μ.

In some embodiments, M_{PDCCH}^{total,slot,μ} is equal to:

$${N}_{cells}^{cap} \cdot {M}_{P D C C H}^{max , slot , μ} \cdot ( {N}_{cells}^{DL , μ} ) / {\sum }_{j = 0}^{3} {N}_{cells}^{DL , j} .$$

N_{cells}^{cap} represents a PDCCH detection capability reported by the terminal, N_{cells}^{DL,j} is determined based on the number of carrier combinations with the parameter set of the scheduling carrier being j, and N_{cells}^{DL,μ} is determined based on the number of carrier combinations with the parameter set of the scheduling carrier being μ.

In some embodiments, the detecting module 920 is further configured to: determine that a maximum number of non-overlapped control channel elements CCEs for channel estimation is less than or equal to min(C_{PDCCH}^{max,slot,μ}, C_{PDCCH}^{total,slot,μ}) in the case that the PDCCH detection is performed on a scheduling carrier corresponding to the carrier combination.

C_{PDCCH}^{max,slot,μ} represents a maximum number of the non-overlapped CCEs for the channel estimation in the carrier combination, and C_{PDCCH}^{total,slot,μ} represents a total number of non-overlapped CCEs for channel estimation of a parameter set corresponding to the carrier combination, wherein the parameter set is a parameter set corresponding to a subcarrier spacing parameter μ.

In some embodiments, C_{PDCCH}^{total,slot,μ} is determined by:

$${C}_{P D C C H}^{total , slot , μ} = ⌊ {N}_{cells}^{c a p} \cdot {C}_{P D C C H}^{max , slot , μ} \cdot ( {N}_{cells}^{DL , μ} ) / {\sum }_{j = 0}^{3} {N}_{cells}^{DL , j} ⌋ .$$

N_{cells}^{cap} represents a PDCCH detection capability reported by the terminal, N_{cells}^{DL,j} is determined based on the number of carrier combinations with the parameter set of the scheduling carrier being j, and N_{cells}^{DL,μ} is determined based on the number of carrier combinations with the parameter set of the scheduling carrier being μ.

In some embodiments, the apparatus further includes: a transmitting module 960, configured to report the PDCCH detection capability N_{cells}^{cap} to a network device.

In some embodiments, N_{cells}^{DL,j} is determined based on the carrier combinations with the parameter set of the scheduling carrier being j and an adjustment coefficient corresponding to the carrier combinations.

In some embodiments, the adjustment coefficient is predefined by a communication protocol or configured by a higher layer signaling.

In some embodiments, the adjustment coefficient is a non-negative number.

In some embodiments, assuming that the number of carrier combinations with the parameter set of the scheduling carrier being 0 (μ=0) is N_{cells}^{DL,1}, cells, the number of carrier combinations with the parameter set of the scheduling carrier being 1 is N_{cells}^{DL,1}, the number of carrier combinations with the parameter set of the scheduling carrier being 2 is N_{cells}^{DL,2}, and the number of carrier combinations with the parameter set of the scheduling carrier being 3 is N_{cells}^{DL,3}, then

$${\sum }_{j = 0}^{3} {N}_{cells}^{DL , j} = {N}_{cells}^{DL , 0} + {N}_{cells}^{DL , 1} + {N}_{cells}^{DL , 2} + {N}_{cells}^{DL , 3}$$

in the case that a count value of each number of the carrier combination is 1 (that is, without the adjustment coefficient).

In some embodiments, N_{cells}^{DL,j} is determined based on the number of at least one carrier combination with the parameter set of the scheduling carrier being j and an adjustment coefficient corresponding to the at least one carrier combination. The adjustment coefficient is predefined by a communication protocol or configured by the network device (higher layer signaling).

In the case of the adjustment coefficient, assuming that the number of carrier combinations with the parameter set of the scheduling carrier being 0 to 3 is N, and an adjustment coefficient corresponding to i^{th} carrier combination is αᵢ, then:

$${\sum }_{j = 0}^{3} {N}_{cells}^{DL , j} = {\sum }_{i = 0}^{N} 1 * {α}_{i} .$$

Assuming that the number of carrier combinations with the parameter set of the scheduling carrier being μ is K, and an adjustment coefficient corresponding to i^{th} carrier combination in the K carrier combinations is αᵢ, then:

$${N}_{cells}^{DL , μ} = {\sum }_{i = 0}^{K} 1 * {α}_{i} .$$

FIG. 10 is a block diagram of an apparatus for transmitting a PDCCH according to some embodiments of the present disclosure. The apparatus for transmitting the PDCCH is achieved as all or part of the terminal. The apparatus includes: a transmitting module 1020, configured to transmit the PDCCH based on a carrier combination, wherein the carrier combination includes one or more carriers.

In some embodiments, the transmitting module 1020 is further configured to: transmit a PDCCH configuration corresponding to the carrier combination.

In some embodiments, the PDCCH configuration corresponding to the carrier combination includes at least one of: PDCCH configuration information corresponding to the carrier combination; a control resource set corresponding to the carrier combination; or a search space set corresponding to the carrier combination.

In some embodiments, the transmitting module 1020 is further configured to: transmit a cross-carrier configuration corresponding to the carrier combination, wherein the cross-carrier configuration includes a value of a carrier indicator field CIF corresponding to the carrier combination.

In some embodiments, the apparatus further includes: a processing module 1040, configured to perform a downlink control information DCI size alignment operation on DCI formats corresponding to the carrier combination in the case that the number of DCI formats corresponding to the carrier combination is greater than a threshold.

In some embodiments, the threshold is 3 for pieces of DCI scrambled by the C-RNTI, and the threshold is 4 for all pieces of DCI.

In some embodiments, the processing module 1040 is configured to determine that the number of PDCCH blind detections is less than or equal to min(M_{PDCCH}^{max,slot,μ}, M_{PDCCH}^{total,slot,μ}) in the case that the PDCCH detection is performed on a scheduling carrier corresponding to the carrier combination.

M_{PDCCH}^{max,slot,μ} represents a maximum number of monitored PDCCH candidates in the carrier combination, and M_{PDCCH}^{total,slot,μ} represents a total number of monitored PDCCH candidates of a parameter set of the scheduling carrier corresponding to the carrier combination, wherein the parameter set is a parameter set corresponding to a subcarrier spacing parameter μ.

In some embodiments, M_{PDCCH}^{total,slot,μ} is equal to

$${N}_{cells}^{cap} \cdot {M}_{P D C C H}^{max , slot , μ} \cdot ( {N}_{cells}^{DL , μ} ) / {\sum }_{j = 0}^{3} {N}_{cells}^{DL , j} .$$

N_{cells}^{cap} represents a PDCCH detection capability reported by the terminal, N_{cells}^{DL,j} is determined based on the number of carrier combinations with the parameter set of the scheduling carrier being j, and N_{cells}^{DL,μ} cells is determined based on the number of carrier combinations with the parameter set of the scheduling carrier being u.

In some embodiments, the processing module 1040 is configured to determine that a maximum number of non-overlapped control channel elements CCEs for channel estimation is less than or equal to min(C_{PDCCH}^{max,slot,μ}, C_{PDCCH}^{total,slot,μ}) in the case that the PDCCH detection is performed on a scheduling carrier corresponding to the carrier combination.

C_{PDCCH}^{max,slot,μ} represents a maximum number of the non-overlapped CCEs for the channel estimation in the carrier combination, and C_{PDCCH}^{total,slot,μ} represents a total number of non-overlapped CCEs for the channel estimation of a parameter set corresponding to the carrier combination, wherein the parameter set is a parameter set corresponding to a subcarrier spacing parameter μ.

In some embodiments, C_{PDCCH}^{total,slot,μ} is determined by:

$${C}_{P D C C H}^{total , slot , μ} = ⌊ {N}_{cells}^{c a p} \cdot {C}_{P D C C H}^{max , slot , μ} \cdot ( {N}_{cells}^{DL , μ} ) / {\sum }_{j = 0}^{3} {N}_{cells}^{DL , j} ⌋ .$$

N_{cells}^{cap} represents a PDCCH detection capability reported by the terminal, N_{cells}^{DL,j} is determined based on the number of carrier combinations with the parameter set of the scheduling carrier being j, and N_{cells}^{DL,μ} is determined based on the number of carrier combinations with the parameter set of the scheduling carrier being μ.

In some embodiments, the apparatus further includes: a receiving module 1060, configured to receive the PDCCH detection capability N_{cells}^{cap} reported by the terminal.

In some embodiments, N_{cells}^{DL,j} is determined based on at least one of the carrier combinations with the parameter set of the scheduling carrier being j and an adjustment coefficient corresponding to each carrier combination in the at least one of the carrier combinations.

In some embodiments, the adjustment coefficient is predefined by a communication protocol or configured by a higher layer signaling. In some embodiments, the adjustment coefficient is a non-negative number.

In some embodiments, assuming that the number of carrier combinations with the parameter set of the scheduling carrier being 0 (μ=0) is N_{cells}^{DL,0}, the number of carrier combinations with the parameter set of the scheduling carrier being 1 is N_{cells}^{DL,1}, the number of carrier combinations with the parameter set of the scheduling carrier being 2 is N_{cells}^{DL,2}, and the number of carrier combinations with the parameter set of the scheduling carrier being 3 is N_{cells}^{DL,3}, then

$${\sum }_{j = 0}^{3} {N}_{cells}^{DL , j} = {N}_{cells}^{DL , 0} + {N}_{cells}^{DL , 1} + {N}_{cells}^{DL , 2} + {N}_{cells}^{DL , 3}$$

in the case that a count value of each number of the carrier combination is 1 (that is, without the adjustment coefficient).

In some embodiments, N_{cells}^{DL,j} is determined based on a number of at least one carrier combination with the parameter set of the scheduling carrier being j and an adjustment coefficient corresponding to the at least one carrier combination. The adjustment coefficient is predefined by a communication protocol or configured by the network device (higher layer signaling).

In the case of the adjustment coefficient, assuming that a number of the carrier combinations with the parameter set of the scheduling carrier being 0 to 3 is N, and an adjustment coefficient corresponding to i^{th} carrier combination is αᵢ:

$${\sum }_{j = 0}^{3} {N}_{cells}^{DL , j} = {\sum }_{i = 0}^{N} 1 * {α}_{i} .$$

Assuming that the number of carrier combinations with the parameter set of the scheduling carrier being μ is K, and an adjustment coefficient corresponding to i^{th} carrier combination in the K carrier combinations is αᵢ, then:

$${N}_{cells}^{DL , μ} = {\sum }_{i = 0}^{K} 1 * {α}_{i} .$$

It should be noted that in the case that the device in the above embodiments achieves the functions, the division of the above functional modules are illustrated. In practical application, the above functional allocation is completed by different functional modules according to actual needs. That is, in terms of structure, the device is divided into different functional modules to complete all or part of functions described above.

In the device in the above embodiments, detailed implementations of operations of the functional modules are described in the embodiments of the method, which are not described in detail herein.

FIG. 11 is a schematic structural diagram of a terminal 1100 according to some embodiments of the present disclosure. The terminal 1100 includes: a processor 1101, a transceiver 1102, and a memory 1103.

The processor 1101 includes one or more processing cores, and the processor 1101 performs various functional applications and information processing by running software programs and modules.

The transceiver 1102 includes a receiver and a transmitter. For example, the receiver and the transmitter are implemented as a same wireless communication assembly, and the wireless communication assembly includes a wireless communication chip and a radio frequency antenna.

The memory 1103 is connected to the processor 1101 and the transceiver 1102.

The memory 1103 is configured to store computer programs executed by the processor. The processor 1101, when loading and executing the computer programs, is caused to perform the method for detecting the PDCCH achieved by the terminal in the above embodiments of the method.

In addition, the memory 1103 is any type of volatile or non-volatile storage device, or a combination thereof, including but not limited to: a disk or optical disc, an electrically erasable programmable read-only memory, an erasable programmable read-only memory, a static random access memory, a read-only memory, a magnetic memory, a flash memory, a programmable read-only memory.

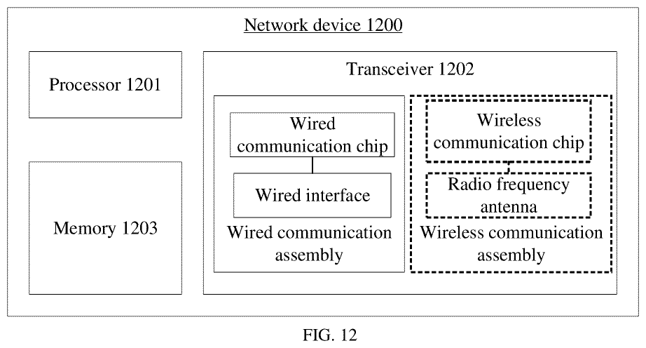

FIG. 12 is a schematic structural diagram of a network device 1200 according to some embodiments of the present disclosure. The network device 1200 includes: a processor 1201, a transceiver 1202, and a memory 1203.

The processor 1201 includes one or more processing cores, and the processor 1202 performs various functional applications and information processing by running software programs and modules.

The transceiver 1202 includes a receiver and a transmitter. For example, the transceiver 1202 includes a wired communication assembly, and the wired communication assembly includes a wired communication chip and a wired interface (such as, an optical fiber interface). In some embodiments, the transceiver 1202 further includes a wireless communication assembly, and the wireless communication assembly includes a wireless communication chip and a radio frequency antenna.

The memory 1203 is connected to the processor 1201 and the transceiver 1202.

The memory 1203 is configured to store computer programs executed by the processor. The processor 1201, when loading and executing the computer programs, is caused to perform the method for transmitting the PDCCH achieved by the network device in the above embodiments of the method.

In addition, the memory 1203 is any type of volatile or non-volatile storage device, or a combination thereof, including but not limited to: a disk or optical disc, an electrically erasable programmable read-only memory, an erasable programmable read-only memory, a static random access memory, a read-only memory, a magnetic memory, a flash memory, a programmable read-only memory.

In some embodiments, the embodiments of the present disclosure further provide a computer-readable storage medium. The computer-readable storage medium stores at least one instruction, at least one program, a code set, or an instruction set. The at least one instruction, at least one program, a code set, or an instruction set, when loaded and executed by a processor, causes the processor to perform the method for detecting the PDCCH achieved by the terminal or the method for transmitting the PDCCH achieved by the network device in the above embodiments.

In some embodiments, the embodiments of the present disclosure further provide a computer program product or a computer program. The computer program product or a computer program includes computer instructions. The computer instructions are stored in a computer-readable storage medium. The computer instructions, when read and executed by a processor of a communication device from the computer-readable storage medium, cause the communication device to perform the method for detecting the PDCCH achieved by the terminal or the method for transmitting the PDCCH achieved by the network device in the above embodiments.

1. A method for detecting a physical downlink control channel PDCCH, applicable to a terminal, the method comprising:
performing a PDCCH detection based on a carrier combination, wherein the carrier combination comprises one or more carriers.

2. The method according to claim 1, wherein the carrier combination is preconfigured by a higher layer signaling.

3. The method according to claim 1, wherein the one or more carriers in the carrier combination are configured with a same subcarrier spacing.

4. The method according to claim 1, wherein the one or more carriers in the carrier combination are configured with a same physical uplink control channel PUCCH group.

5. The method according to claim 1, wherein performing the PDCCH detection based on the carrier combination comprises:
performing a PDCCH blind detection based on a PDCCH configuration defined by a network device for the carrier combination.

6. The method according to claim 5, further comprising:
receiving the PDCCH configuration corresponding to the carrier combination from the network device.

7. The method according to claim 6, wherein the PDCCH configuration corresponding to the carrier combination comprises: a search space set corresponding to the carrier combination.

8. The method according to claim 5, further comprising:
determining a scheduled carrier combination based on a value of a carrier indicator field CIF carried in the PDCCH in a case that the PDCCH blind detection is successful.

9. A terminal, comprising:
a processor;
a transceiver connected to the processor; and
a memory configured to store one or more instructions executable by the processor;
wherein the processor, when loading and executing the one or more instructions, causes the terminal to:
perform a physical downlink control channel PDCCH detection based on a carrier combination, wherein the carrier combination comprises one or more carriers.

10. The terminal according to claim 9, wherein the carrier combination is preconfigured by a higher layer signaling.

11. The terminal according to claim 9, wherein the one or more carriers in the carrier combination are configured with a same subcarrier spacing.

12. The terminal according to claim 9, wherein the one or more carriers in the carrier combination are configured with a same physical uplink control channel PUCCH group.

13. The terminal according to claim 9, wherein the processor, when loading and executing the one or more instructions, causes the terminal to:
perform a PDCCH blind detection based on a PDCCH configuration defined by a network device for the carrier combination.

14. The terminal according to claim 13, wherein the processor, when loading and executing the one or more instructions, causes the terminal to:
receive the PDCCH configuration corresponding to the carrier combination from the network device.

15. The terminal according to claim 14, wherein the PDCCH configuration corresponding to the carrier combination comprises: a search space set corresponding to the carrier combination.

16. The terminal according to claim 13, wherein the processor, when loading and executing the one or more instructions, causes the terminal to:
determine a scheduled carrier combination based on a value of a carrier indicator field CIF carried in the PDCCH in a case that the PDCCH blind detection is successful.

17. A network device, comprising:
a processor;
a transceiver connected to the processor; and
a memory configured to store one or more instructions executable by the processor;
wherein the processor, when loading and executing the one or more instructions, causes the network device to:
transmit a PDCCH based on a carrier combination, wherein the carrier combination comprises one or more carriers.

18. The network device according to claim 17, wherein the carrier combination is preconfigured by a higher layer signaling.

19. The network device according to claim 17, wherein the one or more carriers in the carrier combination are configured with a same subcarrier spacing.

20. The network device according to claim 17, wherein the one or more carriers in the carrier combination are configured with a same physical uplink control channel PUCCH group.
